(19) United States
(12) Patent Application Publication
(10) Pub. No.: US 2015/0371298 A1
(43) Pub. Date: Dec. 24, 2015

(54) GROUP BIDDING SYSTEM AND METHOD

(71) Applicant: James Xu, Chicago, IL (US)

(72) Inventor: James Xu, Chicago, IL (US)

(21) Appl. No.: 14/311,315

(22) Filed: Jun. 22, 2014

(51) Int. Cl. G06Q 30/06; G06Q 20/12; G06Q 30/08

(52) U.S. Cl. CPC G06Q 30/0605; G06Q 30/08; G06Q 20/12

(57) ABSTRACT

This invention concerns a group bidding system and method capable of aggregating conditional purchase offers of at least one product from multiple buyers and communicating such conditional purchase offers to one seller or multiple sellers of said product, comprising a central control system, a database, a buyer interface, a seller interface, a credit verification interface, and a payment interface.

### BACKGROUND OF THE INVENTION

1. Field of the Invention

The present invention relates to a group bidding system and method. More specifically, my invention is primarily relates to a group bidding system and method to gather the conditional purchase offers for a specific product from multiple potential buyers, aggregate the prices of such conditional purchase offers, and communicate the aggregated prices and volume of such product to seller or sellers of such product. The current invention enables the buyers with different expectations in prices for same product to aggregate their demands together, and communicate such total prices and volumes for the same product to the seller or sellers of the product. One buyer who offers a lower than seller's willing-to-sell price for the product will be able to purchase the product, because the other buyer who offers a higher than seller's willing-to-sell price for the same product. The current invention enables seller to be able to sell product at maximum number to a certain group of buyers at an average price equal or above seller's willing-to-sell price. The current invention also enables buyers to group together their demand and total prices for the product and make a bid to the seller of such product.

2. Description of the Prior Art

Group bidding or group purchase has been widely adopted by today's market to sell of various products and services. In most of group bidding system, seller sets a base price for a product or service, and allows multiple buyers to make bid for such product or service over a specific period of time. By the end of the day, the bidder with highest price purchases such product or service from seller.

Currently there are two major auction methods, which are represented by underlying patent for priceline U.S. Pat. No. 5,794,207, and groupon U.S. Pat. No. 6,269,343.

U.S. Pat. No. 5,794,207 issued to Walker et al. in 1998 discloses a method and apparatus for a cryptographically assisted commercial network system designed to facilitate buyer-driven conditional purchase offers. The invention is a method and apparatus for effectuating bilateral buyer-driven commerce. The invention allows prospective buyers of goods and services to communicate a binding purchase offer globally to potential sellers, for sellers conveniently to search for relevant buyer purchase offers, and for sellers potentially to bind a buyer to a contract based on the buyer's purchase offer. In a preferred embodiment, the apparatus of the invention includes a controller which receives binding purchase offers from prospective buyers. The controller makes purchase offers available globally to potential sellers. Potential sellers then have the option to accept a purchase offer and thus bind the corresponding buyer to a contract. The method and apparatus of the invention have applications on the Internet as well as conventional communications systems such as voice telephone.

U.S. Pat. No. 6,269,343 issued to Pallakoff in 2001 discloses an on-line marketing system and method. The invention provides a method and system that allows sellers to communicate conditional offers to potential buyers. The conditions include prices that depend on the aggregate amount of goods or services that buyers collectively agree to purchase by a given time and date. The invention facilitates “demand aggregation,” that is, aggregating demand by potential buyers (who may or may not know each other), for products offered by sellers. This invention allows sellers conveniently to offer “Demand-Based Pricing,” that is, prices which go down as the volume of units sold in a given offer goes up. A seller can therefore offer volume discounts to buyers acting as a group, even when the buyers may not have any formal relationship with one another.

U.S. Pat. No. 7,620,619 issued to Walker et al. in 2009 discloses a conditional purchase offer management system. A conditional purchase offer (CPO) management system is disclosed for receiving CPOs from one or more customers, such as airline passengers, and for evaluating the received CPOs against a number of CPO rules defined by a plurality of sellers, such as airlines, to determine whether any seller is willing to accept a given CPO. A CPO is a binding offer containing one or more conditions submitted by a customer for purchase of an item, such as airline travel, at a customer-defined price. A

CPO rule is a set of restrictions defined by a given seller, such as an airline, to define a combination of restrictions for which the seller is willing to accept a predefined price. The CPO rules may be securely stored by one or more servers. The CPO management system permits a seller to correct for forecasting errors, if necessary, or other competitive forces which have produced excess capacity, by providing inventory for sale to CPO customers

U.S. Pat. Nos. 5,794,207 and 7,620,619 disclose inventions that allows one single buyer to make an offer to bid for the product or service the single buyer needed; the invention then auctions such bid to various available provider of such product or service; the acceptance of such bid by the first available provider concludes the process; and a contract is formed for the single buyer to purchase such product or service from that first available provider at the bidding price offered by the single buyer. Such invention allows the sellers of product and service to know the offer price to purchase product or service from each potential single buyer. The power to form the contract is in the hand of the sellers. The single buyer does not have any power to negotiate with seller, or push the seller to sell the product or service at certain price. This invention deals with the situation of one buyer facing multiple sellers to provide same product or service.

U.S. Pat. No. 6,269,343 discloses an invention that allows a group of buyers to purchase a product or service at a discounted price when certain aggregation in demand is reached. Such invention allows the seller to sell product or service at a pre-determined discounted price determined by seller upon reaching of certain demand aggregation. The buyers in this case do not have any power to negotiate with seller, or push the seller to sell the product or services at certain price. This invention deals with the situation of multiple buyers facing one seller of one product or service with predetermined number of buyers set by seller. This invention facilitates sales of product and service by the seller through demand aggregation that benefits seller only, because the selling price of the product and service was preset by seller before it communicates to the buyers.

The prior arts disclose two methods that are related to the present invention. One is priceline style that allows one buyer to make an offer to purchase one product or service from various sellers who might be willing to accept said buyer's offer. The other one is groupon style that allows one seller to make an offer to sell one product or service at a price with a condition that certain number of buyers are needed to purchase such product or service at same offered price from said seller within certain period of time. In priceline style, buyer would not be able to purchase the product or service, unless buyer's offer price is within seller's selling term. Therefore, all the buyers actually purchase the product or service at seller's willing-to-sell price. In groupon style, all the buyers actually purchase the product or service at seller's willing-to-sell price and at seller's willing-to-sell volume, otherwise, there would be no sell at all.

What is needed then is a system and method to help buyers to take advantage of demand aggregation to push seller of product and service to sell such product and service at a price offered by buyers.

Accordingly, it is a principal objective of my invention to provide a group bidding system and method that is capable of aggregating demand for one product or service from various buyers to form a buying group for such one product or service;

It is a further objective of my invention to provide a group bidding system and method that is capable of aggregating different prices for such one product or service from various buyers to form a total conditional offer price;

It is a still further objective of my invention to provide a group bidding system and method that is capable of communicating such aggregated demand and such total conditional offer price to one seller or multiple sellers of such product or service;

It is a still further objective of my invention to provide a group bidding system and method that is capable of providing negotiation leverage on behalf of the buyers.

It is a still further objective of my invention to provide a group bidding system and method that is capable of helping all or some of the buyers to purchase product or service at buyer's conditional offer price.

Other objects of my invention, as well as particular features, elements, and advantages thereof, will be elucidated in, or apparent from, the following description and the accompanying drawing figures.

### SUMMARY OF THE INVENTION

According to my present invention, I have provided a group bidding system and method capable of helping buyers, rather than sellers, of product and service to take advantage of demand aggregation for product and service.

The present invention provides a group bidding system that is capable of aggregating purchase offers of at least one product from multiple buyers and bidding such purchase offers to one seller or multiple sellers of said at least one product. Said group bidding system comprises a central control system, said central control system capable of processing said purchase offers of at least one product from said multiple buyers and communicating said purchase offers to said one seller or said multiple sellers of said product; a database, said database being controlled and accessed by said central control system; a buyer interface, said buyer interface being controlled by said central control system, and being accessed by both said central control system and said multiple buyers; a seller interface, said seller interface being controlled by said central control system, and being accessed by both said central control system and said one seller or said multiple sellers; a credit verification interface, said credit verification interface being accessed by both said central control system, said multiple buyers, and said one seller or said multiple sellers; and a payment interface, said payment interface being accessed by both said central control system, said multiple buyers, and said one seller or said multiple sellers.

Said central control system is capable of processing said purchase offers of at least one product from said multiple buyers according to a first set of pre-determined rules, said first set of pre-determined rules being disclosed to said multiple buyers, and communicating such purchase offers to said one seller or said multiple sellers of said product according to a second set of pre-determined rules, said second set of pre-determined rules being disclosed to said one seller or said multiple sellers.

Said central control system is also capable of repeating a routine of process of said purchase offers of at least one product from said multiple buyers according to said first set of pre-determined rules, and communicating said purchase offers to said one seller or said multiple sellers of said product according to said second set of pre-determined rules, according to a third set of pre-determined rules, said third set of pre-determined rules including exclusion of one or more lowest purchase offers from said purchase offers before repeating said routine of process of said purchase offers and communicating said purchase offers.

Said purchase offers of at least one product from said multiple buyers include different offer prices of said at least one product, the sum of said diffident offer prices of said at least one product being communicated to said one seller or said multiple sellers of said at least one product.

Said one seller or said multiple sellers of said at least one product has a choice to either accept, reject, or accept part and reject part of said purchase offers of said at least one product from said multiple buyers.

Said multiple buyers, whose said purchase offers being accepted by said one seller or said multiple sellers, cannot withdraw said purchase offers upon acceptance by said one seller or said sellers.

The present invention also provides a group bidding method that is capable of aggregating conditional purchase offers of at least one product from multiple buyers and communicating such conditional purchase offers to one seller or multiple sellers of said at least one product. Said group bidding method comprises gathering conditional purchase offers from said multiple buyers for at least one product by a central control system; processing said conditional purchase offers by said central control system according to a first set of pre-determined rules, said first set of pre-determined rules being disclosed to said multiple buyers; communicating said conditional purchase offers by said central control system to one seller or multiple sellers of said at least one product according to a second set of pre-determined rules, said second set of pre-determined rules being disclosed to said one seller or said multiple sellers; receiving a decision by said central control system from said one seller or said multiple sellers, said decision being either acceptance, rejection, or partial acceptance and partial rejection of said conditional purchase offers; and communicating said decision by said central control system to said multiple buyers.

Said central control system comprises a database, said database being controlled and accessed by said central control system; a buyer interface, said buyer interface being controlled by said central control system, and accessed by both' said central control system and said multiple buyers; a seller interface, said seller interface being controlled by said central control system, and accessed by both said central control system and said one seller or said multiple sellers; a credit verification interface, said credit verification interface being accessed by both said central control system, said multiple buyers, and said one seller or said multiple sellers; and a payment interface, said payment interface being accessed by both said central control system, said multiple buyers, and said one seller or said multiple sellers.

Said central control system is capable of repeating a routine of processing said conditional purchase offers of said at least one product from said multiple buyers according to said first set of pre-determined rules, and communicating said conditional purchase offers to said one seller or said multiple sellers of said at least one product according to said second set of pre-determined rules, according to a third set of pre-determined rules, said third set of pre-determined rules including exclusion of one or more lowest conditional purchase offers from said conditional purchase offers before repeating said routine of processing said conditional purchase offers and communicating said conditional purchase offers, upon receiving a decision by said central control system from said one seller or said multiple sellers, said decision being either rejection, or partial acceptance and partial rejection of said conditional purchase offers.

Said conditional purchase offers of said at least one product from said multiple buyers include different conditional offer prices of said product.

Said first set of pre-determined rules include a credit verification process of said multiple buyers through said credit verification interface, and a payment process by said multiple buyers for making said conditional purchase offers through said payment interface.

Said one seller or said multiple sellers makes decision to accept, reject, or partially accept and partially reject said conditional purchase offers.

Said multiple buyers, whose conditional purchase offers being accepted by said one seller or said multiple sellers, cannot withdraw said conditional purchase offers upon acceptance by said one seller or said multiple sellers.

In a car sale scenario, most of the dealers adopt priceline style. Assume a buyer has decided to purchase certain maker and model car. This buyer will go to different dealers for such maker and shop for such model car. Each time, this buyer needs to make an offer to purchase such model car. Dealer will not accept buyer's offer, unless buyer's offer is at least as much as dealer's willing-to-sell price for such model car. If dealers adopt groupon style, dealer will offer certain maker and model car at certain price, but with a condition that within certain period of time, there must be certain number of cars being sold to one or a few buyers. In neither case, a car buyer will have to purchase car at dealer's willing-to-sell price. The only difference between priceline style and groupon style is that with the priceline style, the buyer does not know dealer's willing-to-sell price, and with the groupon style, the buyer knows dealer's willing-to-sell price.

The present invention provides a system and method allows car buyers to be able to group together their purchase demand as well as purchase price to make a bid to the car seller, while there is no need for such group of car buyers, who want to buyer same maker and/or model car, to actually know each other to form such a purchase group. For example, car buyer A wants to purchase Maker M Model M for $35,000, car buyer B wants to purchase Maker M Model M for $36,000, and car buyer C wants to purchase Maker M Model M for $37,000. This invention allows car buyer A, car buyer B and car buyer C to form a purchase group, and to make an offer to purchase three Maker M Model M cars for the sum of $35,000, $36,000 and $37,000, which is $108,000, but without disclosing each individual price of $35,000, $36,000, and $37,000. There are only two possibilities for such bid. The first possibility is that $108,000 is above car seller's willing-to-sell price for three Maker M Model M cars, which leads to car seller's acceptance to sell three Make M Model M cars to car buyer A, car buyer B and car buyer C together. The second possibility is that $108,000 is below seller's willing-to-sell price for three Maker M Model M cars. In reality, the second possibility is much more likely to happen than the first possibility. Under the second possibility, car seller will make a counter offer to sell three Maker M Model M cars, for example, at a total price of $109,200. This counter offer most often means that car seller's willing-to-sell price of one Maker M Model M car is one third of $109,200, which equals $36,400. With such information, car buyer B and car buyer C shall be able to make an offer to purchase two Maker M Model M cars for the sum of $36,000 and $37,000, which equals to $73,000, which is more than $36,400, car seller's willing-to-sell price.

The present invention provides a system and method to enable hundreds and thousands of car buyers to aggregate their offers for same, similar or different cars, and make a group bid to car sellers. The present invention enables car buyer whose purchase offer is lower than car seller's willing-to-sell price to be able to purchase the car due to the fact that there are other car buyers in the group who offers more than car seller's willing-to-sell price.

Currently, the auto industry's sales are mostly done through the dealers. On the one hand, dealers have to spend a lot of money on car inventory. On the other hand, dealers take advantage of its knowledge and power over the car buyers to sell each car at great profit. Currently, dealers are engaged in both the car sales and car services. The present invention, in the long run, will revolutionize the auto industry to enable the car sales through manufacturer directly without the involvement of car dealers. Car buyers will purchase the car through the manufacturer directly. Car buyers will only test drive at the dealer and pick up car at the dealer. This way, the manufacturer will be able to make car per orders, and dealers will have no need to spend huge amount of money on car inventory. Dealers' function will change from both sale and service to service only.

The present invention can also be used to group buyers for various products and services, including electronics, equipments, restaurants, airline tickets, etc.

Other technical advantages will be readily apparent to one skilled in the art from the following figures, descriptions and claims. Moreover, while specific advantages have been enumerated above, various embodiments may include all, some or one of the enumerated advantages.

### DESCRIPTION OF THE DRAWINGS

Other features of my invention will become more evident from a consideration of the following detailed description of my patent drawings, as follows:

FIG. 1 is a structure demonstration drawing of the preferred embodiment of current invention;

FIG. 2 is a flow chart for the first method of gathering bids by the preferred embodiment of current invention.

FIG. 3 is a flow chart for the second method of gathering bids by the preferred embodiment of current invention.

FIG. 4 is a flow chart for the method of communicating bids to the seller by the preferred embodiment of current invention.

FIG. 5 is a flow chart for the group bidding method by the preferred embodiment of current invention.

FIG. 6 is an illustration of a First Application of the preferred embodiment of current invention.

FIG. 7 is an illustration of a Second Application of the preferred embodiment of current invention with exclusion of the buyer with lowest bidding price.

FIG. 8 is an illustration of a Third Application of the preferred embodiment of current invention with exclusion of the buyer with lowest bidding price.

FIG. 9 is an illustration of a Fourth Application of the preferred embodiment of current invention with exclusion of the buyer with lowest bidding price.

### DETAILED DESCRIPTION OF THE PREFERRED EMBODIMENT

Referring now to the drawings, my invention concerns a group bidding system capable of aggregating purchase offers of at least one product from multiple buyers and bidding such purchase offers to one seller or multiple sellers of said at least one product.

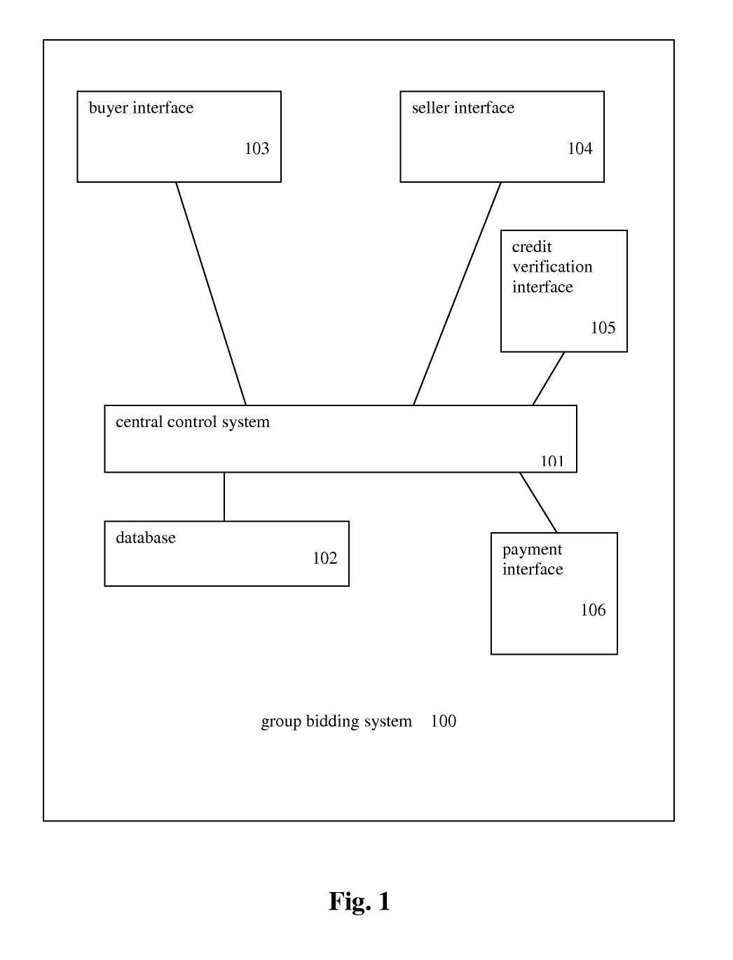

Referring now to FIG. 1, which is a structure demonstration drawing of the preferred embodiment of current invention 100. Said group bidding system 100 comprises a central control system 101, said central control system 101 capable of processing said purchase offers of at least one product from said multiple buyers and communicating said purchase offers to said one seller or said multiple sellers of said product; a database 102, said database 102 being controlled and accessed by said central control system 101; a buyer interface 103, said buyer interface 103 being controlled by said central control system 101, and being accessed by both said central control system 101 and said multiple buyers; a seller interface 104, said seller interface 104 being controlled by said central control system 101, and being accessed by both said central control system 101 and said one seller or said multiple sellers; a credit verification interface 105, said credit verification interface 105 being accessed by both said central control system 101, said multiple buyers, and said one seller or said multiple sellers; and a payment interface 106, said payment interface 106 being accessed by both said central control system 101, said multiple buyers, and said one seller or said multiple sellers.

Said central control system 101 is capable of processing said purchase offers of at least one product from said multiple buyers according to a first set of pre-determined rules, said first set of pre-determined rules being disclosed to said multiple buyers, and communicating such purchase offers to said one seller or said multiple sellers of said product according to a second set of pre-determined rules, said second set of pre-determined rules being disclosed to said one seller or said multiple sellers.

Said central control system 101 is capable of repeating a routine of process of said purchase offers of at least one product from said multiple buyers according to said first set of pre-determined rules, and communicating said purchase offers to said one seller or said multiple sellers of said product according to said second set of pre-determined rules, according to a third set of pre-determined rules, said third set of pre-determined rules including exclusion of one or more lowest purchase offers from said purchase offers before repeating said routine of process of said purchase offers and communicating said purchase offers. Said first set of pre-determined rules shall be followed by said multiple buyers. Said first set of pre-determined rules are for the purpose of gathering more potential buyers for specific products, and promoting potential buyers to make reasonable offers. Said first set of pre-determined rules are set by the administrator of said central control system 101. Said second set of pre-determined rules are for the purpose of communicating offers from buyers to one seller or multiple sellers, and promoting potential seller or sellers to accept offers from the buyers. Said second set of pre-determined rules are set by the administrator of said central control system 101. Said third set of pre-determined rules is for the purpose of modifying the way of grouping and re-grouping offers from buyers to meet the requirements of the counter offer from, seller, or to make another offer to the seller. Said third set of pre-determined rules are set by the administrator of said central control system 101.

Said purchase offers of at least one product from said multiple buyers include different offer prices of said at least one product, the sum of said diffident offer prices of said at least one product being communicated to said one seller or said multiple sellers of said at least one product. The central control system 101 only communicates the total volume of purchase and the total purchase prices to the seller or sellers. The central control system 101 does not disclose each individual purchase offer for the product or service from each individual buyer to the seller or sellers.

Said one seller or said multiple sellers of said at least one product has a choice to either accept, reject, or accept part and reject part of said purchase offers of said at least one product from said multiple buyers.

Said multiple buyers, whose said purchase offers being accepted by said one seller or said multiple sellers, cannot withdraw said purchase offers upon acceptance by said one seller or said sellers.

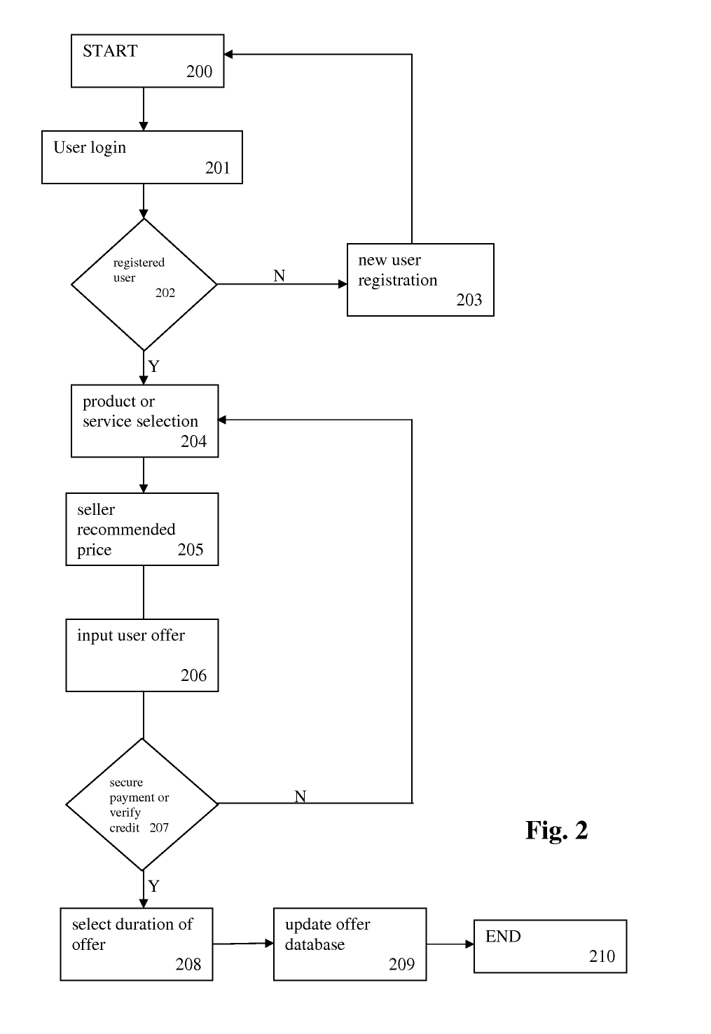

Referring now to FIG. 2, which is a flow chart for the first method of gathering bids by the preferred embodiment of current invention. Said method starts out at step 200 and proceeds to step 201. At step 201, the method enables user to login, and then proceeds to step 202. At step 202, the method verifies whether user is a registered user. If the answer at step 202 is no, the method proceeds to step 203. At step 203, the method requires the user to do a new user registration. At step 203, a new user needs to provide all the required information for registration. Such information is processed and administrated by said central control system 101, and become a part of database 102. If the answer at step 202 is yes, the method proceeds to step 204. At step 204, the method allows user to select a product or service from the product and service list, and then proceeds to step 205. At step 205, the method provides user a seller recommended price for the product or service selected by the user at step 204, and then proceeds to step 206. At step 206, the method allows user to input his or her offer, which is his or her bid price for the product or service selected by user at step 204; and then proceeds to step 207. At step 207, the method requires user to provide payment or credit, depending upon the requirement associated with the product or service selected by user at step 204. The method processes payment through payment interface 106, and credit verification through credit verification interface 105. Upon completion of payment or credit process, the method proceeds to step 208. At step 208, the method allows user to select duration of his or her offer from a preset duration list, and then proceeds to step 209. At step 209, the method updates the offer database, which becomes a part of database 102. The method then proceeds to the end at step 210.

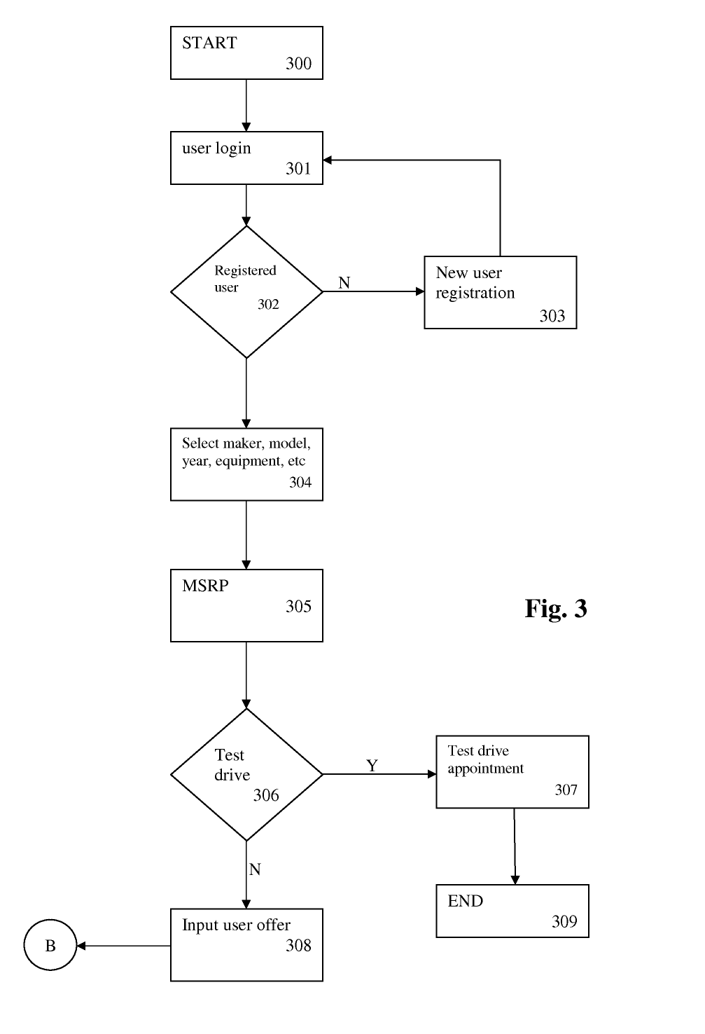

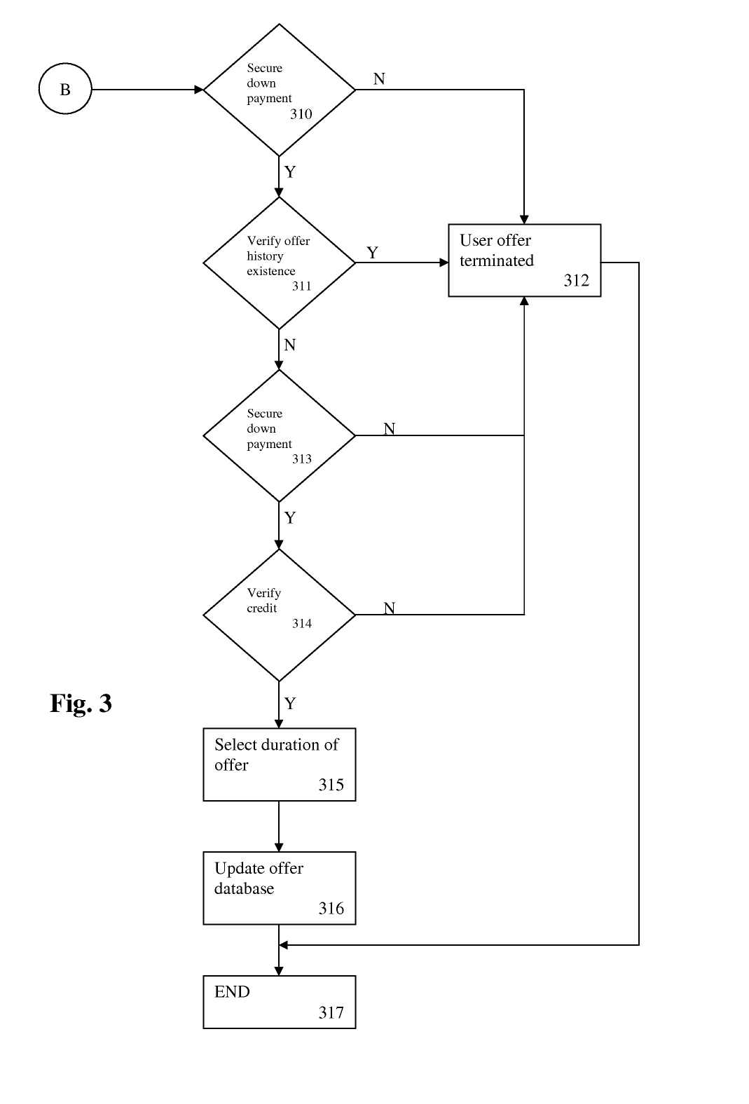

Referring now to FIG. 3, which is a flow chart for the second method of gathering bids by the preferred embodiment of current invention. This method is specific to car purchase. Said method starts out at step 300 and proceeds to step 301. At step 301, the method enables user to login, and then proceeds to step 302. At step 302, the method verifies whether user is a registered user. If the answer at step 302 is no, the method proceeds to step 303. At step 303, the method requires the user to do a new user registration. At step 303, a new user needs to provide all the required information for registration. Such information is processed and administrated by said central control system 101, and become a part of database 102. If the answer at step 302 is yes, the method proceeds to step 304. At step 304, the method allows user to select all the variables associated with a car, such as year, maker, model, style, color, interior, exterior, etc., and proceeds to step 305. At step 305, the method provides user with MSRP of the car selected by user at step 304, then proceeds to step 306. At step 306, the method asks whether user needs to test drive the car selected at step 304. If the answer at step 306 is yes, the method proceeds to step 307. At step 307, the method allows user to make test drive appointment with a dealer for test drive, and proceeds to step 309. The method ends at step 309 to allow user time to do the test drive at dealer selected by user at step 307. Upon completion of the test drive, the method allows user to start the process again at step 300. If the answer at step 306 is no, the method proceeds to step 308. At step 308, the method allows user to input his or her offer, which is his or her bid price for the car selected at step 304, and then proceeds to step 301. At step 311, the method verifies whether user's offer history to see if there is existing offer made by user for the same or similar car. If the answer at step 311 is yes, the method terminates user's offer at step 312 due to duplication, and proceeds to step 317. The method ends at step 317. If the answer at 311 is no, the method proceeds to step 313. At step 313, the method requires user to provide down payment for purchase the car selected at step 304. If user could not make the required down payment through payment interface 106, the method proceeds to step 312. At step 312, the method terminates user's offer, and proceeds to step 317. The method ends at step 317. If user makes required down payment for purchase the car selected at step 304, the method then proceeds to step 314. At step 314, the method verifies user's credit for the car purchase through credit verification interface 105. If the answer at step 314 is no, which means buyer does not have enough credit to make the car purchase, the method proceeds to step 312. At step 312, the method terminates user's offer, and proceeds to step 317. The method ends at step 317. If the answer to step 314 is yes, which means buyer does have enough credit to make the car purchase, the method proceeds to step 315. At step 315, the method allows user to select duration of his or her offer from a preset duration list, and then proceeds to step 316. At step 316, the method updates the offer database, which becomes a part of database 102. The method then proceeds to the end at step 317.

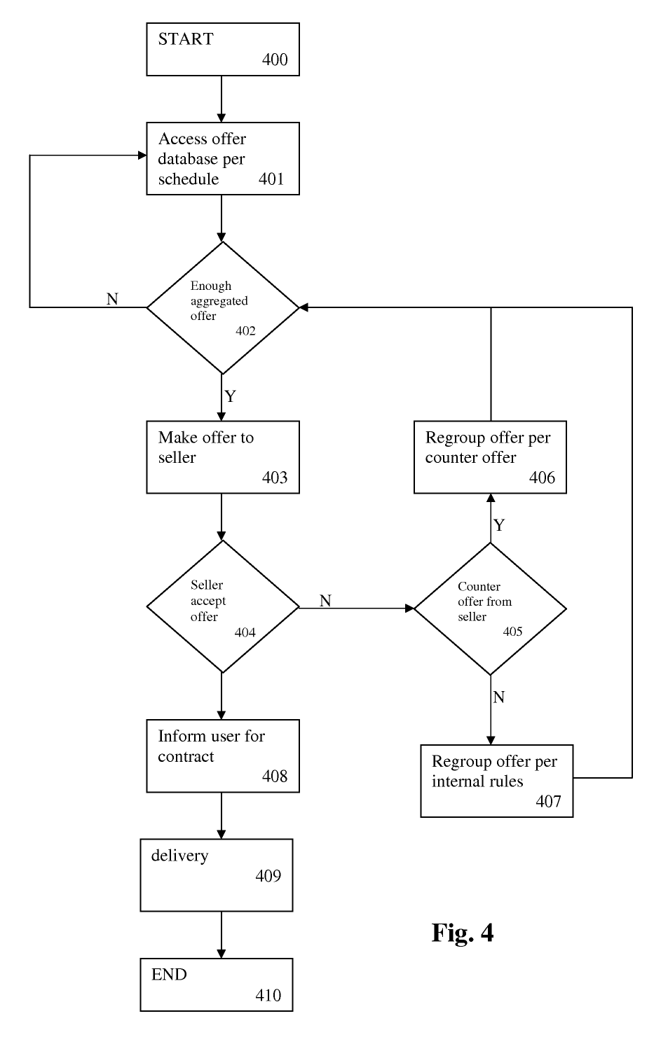

Referring now to FIG. 4, which is a flow chart for the method of communicating bids to the seller by the preferred embodiment of current invention. Said method starts out at step 400 and proceeds to step 401. At step 401, the method enables central control system 101 to access database 102 according to a pre-set schedule, and then proceeds to step 402. At step 402, central control system 101 needs to determine whether there are enough aggregated offers for various products and services. If the answer at step 402 is no, the method proceeds to step 401. If the answer at step 402 is yes, the method proceeds to step 403. At step 403, the central control system 101 communicates an offer to seller to purchase certain product or service at certain sum of amount. The central control system 101 does not disclose each offer from each individual user, but the aggregated total of the offers from all the individual users for the product or service. The method then proceeds to step 404. At step 404, the method accepts decision from seller. The decision can be either an acceptance or rejection of the offer. If the decision at step 404 is an acceptance, the method proceeds to step 408. At step 408, the method informs the users about the acceptance of their offer by the seller, and formation of contract, then proceeds to step 409. At step 409, the method informs the users about the delivery of the product and service, and proceeds to step 410. The method ends at step 410. If the decision at step 404 is a rejection, the method proceeds to step 405. At step 405, the method determines whether the rejection from the seller includes a counter offer. If the answer at step 405 is no, the method proceeds to step 407. At step 407, the method will re-group offers by excluding at least one lowest offer for the product or service, and proceeds to step 402. IF the answer at step 405 is yes, the method proceeds to step 406. At step 406, the method evaluates the counter offer from seller, and re-groups the offers from various users to meet the requirement of counter offer. The method then proceeds to step 402.

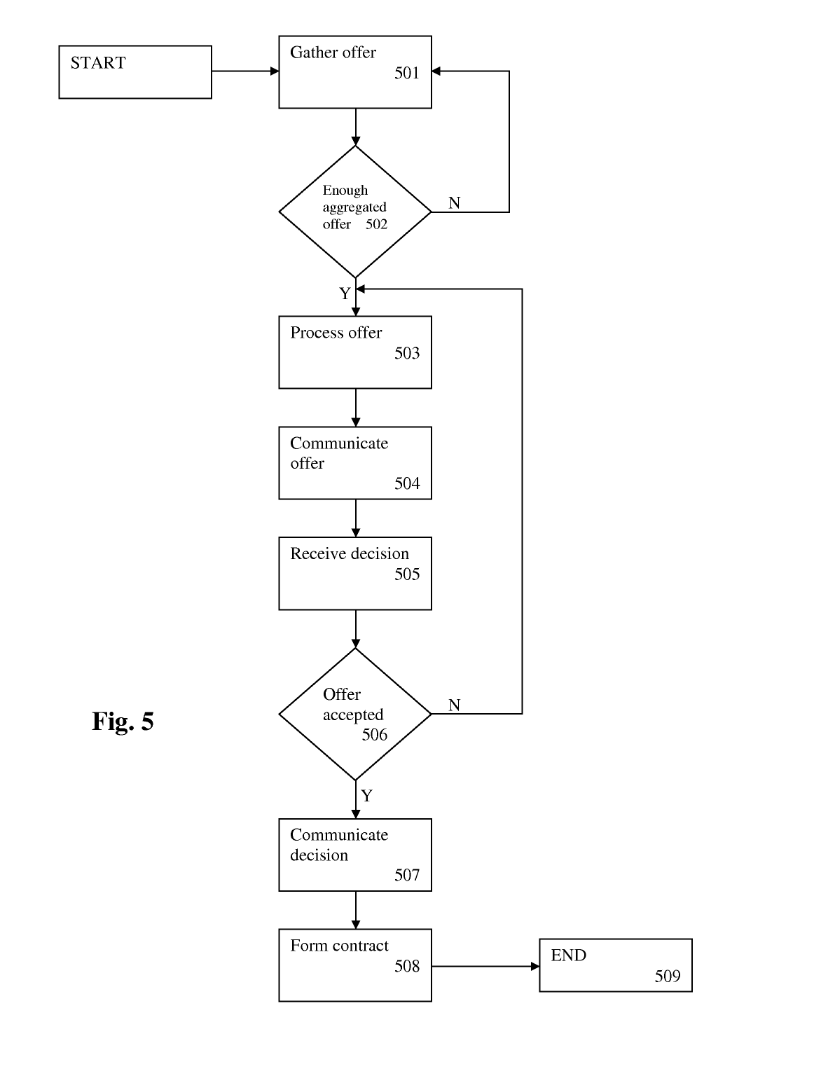

Referring now to FIG. 5, which is a flow chart for the group bidding method by the preferred embodiment of current invention. Said group bidding method is capable of aggregating conditional purchase offers of at least one product from multiple buyers and communicating such conditional purchase offers to one seller or multiple sellers of said at least one product. Said group bidding method comprises a step 1 of gathering conditional purchase offers 501 from said multiple buyers for at least one product by a central control system 101; a step 2 of determining whether there are enough aggregated conditional offers 502 for at least one product; a step 3 of processing said conditional purchase offers 503 by said central control system 101 according to a first set of pre-determined rules, said first set of pre-determined rules being disclosed to said multiple buyers; a step 4 of communicating said conditional purchase offers 504 by said central control system 101 to one seller or multiple sellers of said at least one product according to a second set of pre-determined rules, said second set of pre-determined rules being disclosed to said one seller or said multiple sellers; a step 5 of receiving a decision 505 by said central control system 101 from said one seller or said multiple sellers; a step 6 of determining whether the offer are accepted or rejected by said one seller or said multiple sellers 506 by said central control system 101; a step 7 communicating said decision 507 by said central control system 101 to said multiple buyers; and a step 8 form contract for said multiple buyers, whose conditional purchase offers being accepted by said one seller or said multiple sellers. At step 2, there are not enough aggregated conditional offers, the central control system 101 returns to step 1 to gather more conditional purchase offers.

Said central control system is capable of repeating a routine of step 3 processing said conditional purchase offers 503 of said at least one product from said multiple buyers according to said first set of pre-determined rules, and step 4 communicating said conditional purchase offers 504 to said one seller or said multiple sellers of said at least one product according to said second set of pre-determined rules, according to a third set of pre-determined rules, said third set of pre-determined rules including exclusion of one or more lowest conditional purchase offers from said conditional purchase offers before repeating said routine of step 3 processing said conditional purchase offers 503 and step 4 communicating said conditional purchase offers 504, upon step 5 receiving a decision 505 by said central control system 101 from said one seller or said multiple sellers, said decision being either rejection, or partial acceptance and partial rejection of said conditional purchase offers.

Said conditional purchase offers of said at least one product from said multiple buyers include different conditional offer prices of said product.

Said first set of pre-determined rules include a credit verification process of said multiple buyers through said credit verification interface 105, and a payment process by said multiple buyers for making said conditional purchase offers through said payment interface 106.

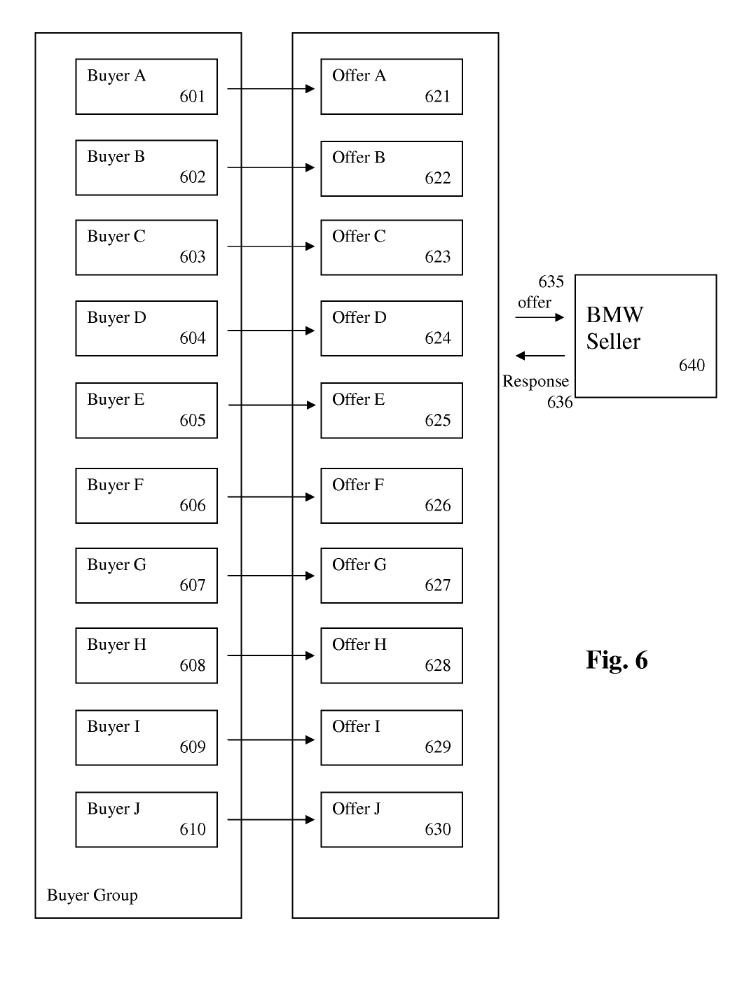

Referring now to FIG. 6, which is an illustration of First Application of the preferred embodiment of current invention. FIG. 6 illustrates an example of ten buyers, all of whom intend to purchase a 2014 BMW X5 xDrive35d with MSRP of $63,575 (“Car”), the price of which is provided by the BMW USA official website.

This invention allows a group of ten buyers to make a bid to purchase ten Cars at the same time. Said first set of pre-determined rules allows central control system 101 to arrange and name such ten buyers according to the offer price from high to low. As the result, said group of ten buyers are named Buyer A 601, Buyer B 602, Buyer C 603, Buyer D 604, Buyer E 605, Buyer F 606, Buyer G 607, Buyer H 608, Buyer I 609 and Buyer J 610 to form a First Buyer Group. Buyer A 601 makes an Offer A 621 to bid for Car in the amount of $63,000; Buyer B 602 makes an Offer B 622 to bid for Car in the amount of $62,900; Buyer C 603 makes an Offer C 623 to bid for Car in the amount of $62,800; Buyer D 604 makes an Offer D 624 to bid for Car in the amount of $62,700; Buyer E 605 makes an Offer B 625 to bid for Car in the amount of $62,600; Buyer F 606 makes an Offer F 626 to bid for Car in the amount of $62,500; Buyer G 607 makes an Offer G 627 to bid for Car in the amount of $62,400; Buyer H 608 makes an Offer H 628 to bid for Car in the amount of $62,300; Buyer I 609 makes an Offer I 629 to bid for Car in the amount of $62,200; and Buyer J 610 makes an Offer J 630 to bid for Car in the amount of $62,100. As the result, central control system 101 following said second set of pre-determined rules to group all the bid amounts from said First Buyer Group and communicate offer 635 to BMW seller 640. Said offer includes purchase of ten Cars at a total price of $625,500, which is the sum all the offers, however, does not includes the identities of each individual buyer of said First Buyer Group. Said BMW seller 640 is provided certain time limit to respond to the central control system 101 regarding said offer. BMW seller 640 communicates response 636 to the central control system 101. If the response 636 is acceptance of said offer 635, the central control system 101 informs said First Buyer Group that said offer 635 has been accepted, and contract has been formed. If the response 636 is a rejection without any further counter offer from BMW seller 640, central control system 101 follows said third set of pre-determined rules to exclude the lowest price, which is Offer J 630 from Buyer J 610, re-group the buyers.

After exclusion of Buyer J 610 who made Offer J 630, this invention allows a group of nine out of ten buyers to make a bid to purchase nine Cars at the same time. As the result, said group of nine buyers, including Buyer A 601, Buyer B 602, Buyer C 603, Buyer D 604, Buyer E 605, Buyer F 606, Buyer G 607, Buyer H 608, and Buyer I 609 to form a Second Buyer Group. Buyer A 601 makes an Offer A 621 to bid for Car in the amount of $63,000; Buyer B 602 makes an Offer B 622 to bid for Car in the amount of $62,900; Buyer C 603 makes an Offer C 623 to bid for Car in the amount of $62,800; Buyer D 604 makes an Offer D 624 to bid for Car in the amount of $62,700; Buyer E 605 makes an Offer A 625 to bid for Car in the amount of $62,600; Buyer F 606 makes an Offer F 626 to bid for Car in the amount of $62,500; Buyer G 607 makes an Offer G 627 to bid for Car in the amount of $62,400; Buyer H 608 makes an Offer H 628 to bid for Car in the amount of $62,300; and Buyer I 609 makes an Offer I 629 to bid for Car in the amount of $62,200. As the result, central control system 101 following said second set of pre-determined rules to group all the bid amounts from said Second Buyer Group and communicate offer 635 to BMW seller 640. Said offer includes purchase of nine Cars at a total price of $563,400, which is the sum all the offers, however, does not includes the identities of each individual buyer of said

Second Buyer Group. Said BMW seller 640 is provided certain time limit to respond to the central control system 101 regarding said offer. BMW seller 640 communicates response 636 to the central control system 101. If the response 636 is acceptance of said offer 635, the central control system 101 informs said Second Buyer Group that said offer 635 has been accepted, and contract has been formed. If the response 636 is a rejection without any further counter offer from BMW seller 640, central control system 101 follows said third set of pre-determined rules to exclude the lowest price, which is Offer J 629 from Buyer J 609, and re-group the buyers. This process of re-group the buyers ends at the time either the offer 635 is accepted by BMW seller 640 or until Offer A 621, which is the highest offer to purchase Car from Buyer A 601 is rejected by BMW seller 640.

If the response 636 is a rejection with an counter offer from BMW seller 640, central control system 101 follows said third set of pre-determined rules to re-group offers from higher offer price to lower offer price to meet the requirement of the counter offer from BMW seller 640, and communicate offer 635 to MBW seller 640 to form a contract. Central control system 101 informs said Second Buyer Group that contract has been formed.

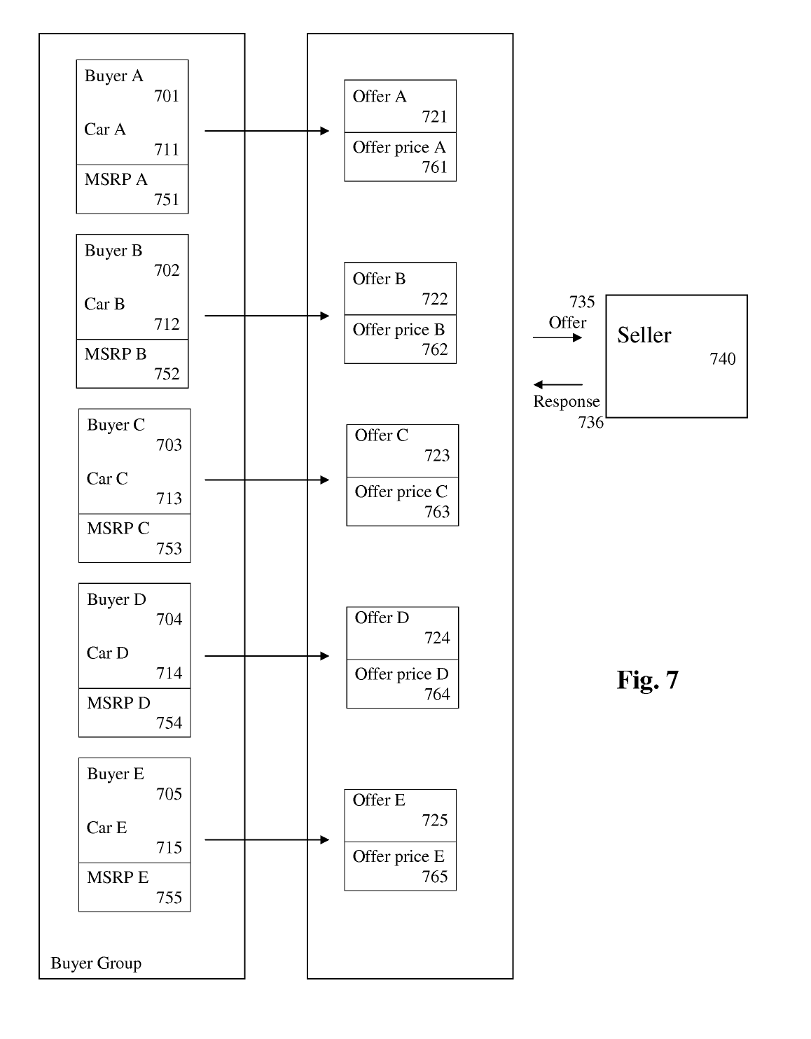

Referring now to FIG. 7, which is an illustration of Second Application of the preferred embodiment of current invention. FIG. 7 illustrates an example of 5 buyers, each of whom intends to purchase a different BMW with different MSRP.

This invention allows this group of five buyers to make a bid to purchase five different cars at the same time. Said first set of pre-determined rules allows central control system 101 to arrange and name such five buyers according to the offer price to MSRP ratio from high to low. As the result, said group of five buyers are named Buyer A 701, Buyer B 702, Buyer C 703, Buyer D 704, and Buyer E 705 to form a Third Buyer Group. Buyer A 701 makes an Offer A 721 to bid for Car A 711 with MSRP A 751 in the amount of offer price A 721 with offer price A 721 to MSRP A 751 ratio of 98%; Buyer B 702 makes an Offer B 722 to bid for Car B 712 with MSRP B 752 in the amount of offer price B 762 with offer price B 762 to MSRP B 752 ratio of 95%; Buyer C 703 makes an Offer C 723 to bid for Car C 713 with MSRP C 753 in the amount of offer price C 723 with offer price C 723 to MSRP C 753 ratio of 93%; Buyer D 704 makes an Offer D 724 to bid for Car D with MSRP D 754 in the amount of offer price D 764 with offer price D 764 to MSRP D 754 ratio of 91%; and Buyer E 705 makes an Offer E 725 to bid for Car E 715 with MSRP E 755 in the amount of offer price E 765 with offer price E 765 to MSRP E 755 ratio of 90%. As the result, central control system 101 following said second set of pre-determined rules to group all the bid amounts from said Third Buyer Group and communicate offer 735 to BMW seller 740. Said offer includes purchase of Car A 711, Car B 712, Car C 713, Car D 714, and Car E 715 all together at a total price of sum of offer price A 761, offer price B 762, offer price C 763, offer price D 764, and offer price E 765, however, does not includes the identities of each individual buyer of said Third Buyer Group. Said BMW seller 740 is provided certain time limit to respond to the central control system 101 regarding said offer 735. BMW seller 740 communicates response 736 to the central control system 101. If the response 736 is acceptance of said offer 735, the central control system 101 informs said Third Buyer Group that said offer 735 has been accepted, and contract has been formed. If the response 736 is a rejection without any further counter offer from BMW seller 640, central control system 101 follows said third set of pre-determined rules to exclude the offer with the lowest offer price to MSRP ratio, which is Offer E 725 from Buyer E 705, re-group the buyers.

After exclusion of Buyer E 705 who made Offer E 725, this invention allows a group of four out of five buyers to make a bid to purchase Car A 711, Car B 712, Car C 713, and Car D 714 all together at the same time. As the result, said group of four buyers, including Buyer A 701, Buyer B 702, Buyer C 703, and Buyer D 704 to form a Fourth Buyer Group. Buyer A 701 makes an Offer A 721 to bid for Car A 711 with MSRP A 751 in the amount of offer price A 721 with offer price A 721 to MSRP A 751 ratio of 98%; Buyer B 702 makes an Offer B 722 to bid for Car B 712 with MSRP B 752 in the amount of offer price B 762 with offer price B 762 to MSRP B 752 ratio of 95%; Buyer C 703 makes an Offer C 723 to bid for Car C 713 with MSRP C 753 in the amount of offer price C 723 with offer price C 723 to MSRP C 753 ratio of 93%; and Buyer D 704 makes an Offer D 724 to bid for Car D with MSRP D 754 in the amount of offer price D 764 with offer price D 764 to MSRP D 754 ratio of 91%. As the result, central control system 101 following said second set of pre-determined rules to group all the bid amounts from said Fourth Buyer Group and communicate offer 735 to BMW seller 740. Said offer includes purchase of Car A 711, Car B 712, Car C 713, and Car D 714 all together at a total price of sum of offer price A 761, offer price B 762, offer price C 763, and offer price D 764, however, does not includes the identities of each individual buyer of said Third Buyer Group. Said BMW seller 740 is provided certain time limit to respond to the central control system 101 regarding said offer 735. BMW seller 740 communicates response 736 to the central control system 101. If the response 736 is acceptance of said offer 735, the central control system 101 informs said Fourth Buyer Group that said offer 735 has been accepted, and contract has been formed. If the response 736 is a rejection without any further counter offer from BMW seller 740, central control system 101 follows said third set of pre-determined rules to exclude the offer with the lowest offer price to MSRP ratio, which is Offer E 725 from Buyer E 705, re-group the buyers. This process of re-group the buyers ends at the time either the offer 735 is accepted by BMW seller 740 or until Offer A 721, which is the highest offer with offer price to MSRP ratio to purchase Car from Buyer A 701 is rejected by BMW seller 740.

If the response 736 is a rejection with an counter offer from BMW seller 740, central control system 101 follows said third set of pre-determined rules to re-group offers from higher offer price to MSRP ratio to lower offer price to MSRP ratio to meet the requirement of the counter offer from BMW seller 740, and communicate offer 735 to MBW seller 740 to form a contract. Central control system 101 informs said Fourth Buyer Group that contract has been formed.

This group bidding system and method demonstrated by FIGS. 6 and 7 provides a group of buyers with the best possibility for the largest number of Cars to be sold by seller to said group buyers at the prices offered by said group of buyers. In a traditional car . purchase scenario, there are usually three parties involved, including car manufacturer, car dealer and car buyer. Manufacturer sets the prices for the cars to be sold to the car dealer. Car dealer's profit is based on its negotiation with each individual car buyer. Car dealer will usually not sell a car to an individual car buyer unless the offer is above dealer's willing-to-sell price, which includes the price offered by the car manufacturer, other dealer costs, and dealer profit. Car dealer will make different amount of profit from different car buyers. This group bidding system and method demonstrated by FIGS. 6 and 7 groups different car buyers into a buyer group, some individual of which might be able to purchase the car below car dealer's willing-to-sell price, because some others are willing to purchase the car above car dealer's willing-to-sell price. This group bidding system and method helps a group of car buyers to purchase a number of cars at a lowest possible average price that just above dealer's willing-to-sell price. This group bidding system and method might be able to help the manufacturers of cars to sale directly to a group of buyers, rather than through car dealers, a method of which incurs so much inventory costs for car dealers. This group bidding system and method might be able to revolutionize the car industry to change car dealer's function from traditional sales and services cars to just services cars.

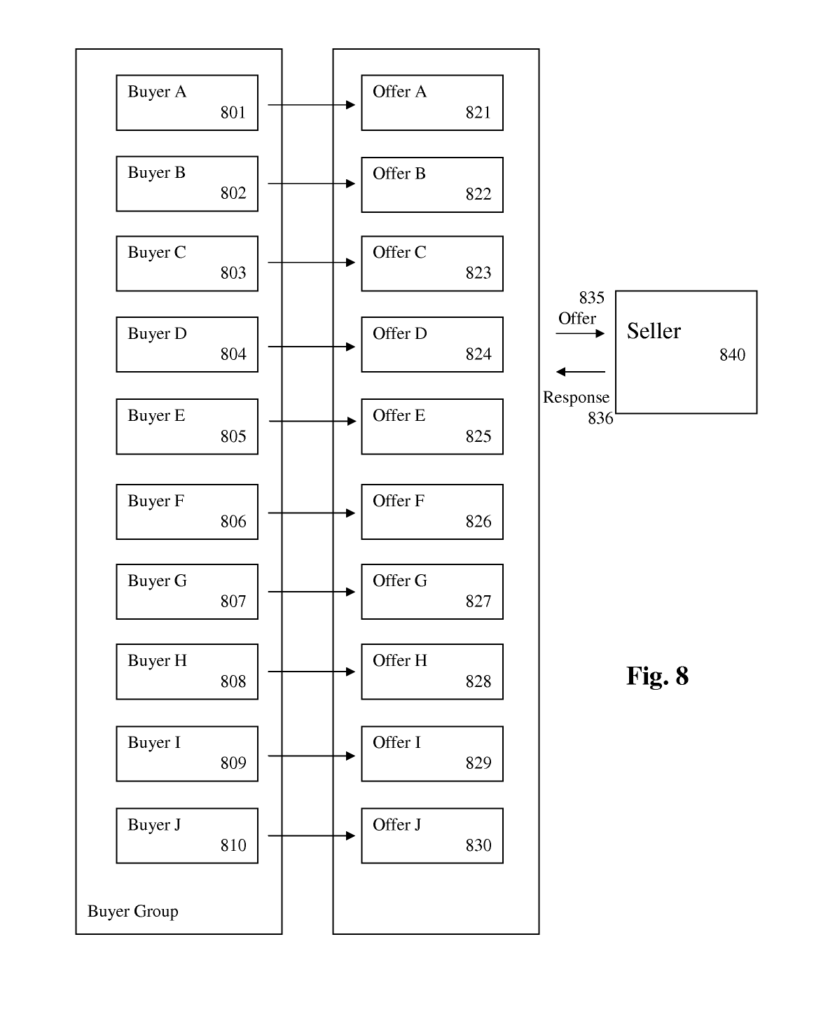

Referring now to FIG. 8, which is an illustration of Third Application of the preferred embodiment of current invention. FIG. 8 illustrates an example of ten buyers, all of whom intend to purchase a specific product, such as a specific brand and model laptop computer with same specific features (“Product”), the market price of which is, let's say, $500.

This invention allows a group of ten buyers to make a bid to purchase ten Product at the same time. Said first set of pre-determined rules allows central control system 101 to arrange and name such ten buyers according to the offer price from high to low. As the result, said group of ten buyers are named Buyer A 801, Buyer B 802, Buyer C 803, Buyer D 804, Buyer E 805, Buyer F 806, Buyer G 807, Buyer H 808, Buyer I 809 and Buyer J 810 to form a Fifth Buyer Group. Buyer A 801 makes an Offer A 821 to bid for Product in the amount of $490; Buyer B 802 makes an Offer B 822 to bid for Product in the amount of $480; Buyer C 803 makes an Offer C 823 to bid for Product in the amount of $470; Buyer D 804 makes an Offer D 824 to bid for Product in the amount of $460; Buyer E 805 makes an Offer E 825 to bid for Product in the amount of $450; Buyer F 806 makes an Offer F 826 to bid for Product in the amount of $440; Buyer G 807 makes an Offer G 827 to bid for Product in the amount of $430; Buyer H 808 makes an Offer H 828 to bid for Product in the amount of $420; Buyer I 809 makes an Offer I 829 to bid for Product in the amount of $410; and Buyer J 810 makes an Offer J 830 to bid for Product in the amount of $400. As the result, central control system 101 following said second set of pre-determined rules to group all the bid amounts from said Fifth Buyer Group and communicate offer 835 to Seller of Product 840. Said offer includes purchase of ten Products at a total price of $4,450, which is the sum all the offers, however, does not includes the identities of each individual buyer of said Fifth Buyer Group. Said Seller of Product 840 is provided certain time limit to respond to the central control system 101 regarding said offer. Said Seller of Product 840 communicates response 836 to the central control system 101. If the response 836 is acceptance of said offer 835, the central control system 101 informs said Fifth Buyer Group that said offer 835 has been accepted, and contract has been formed. If the response 836 is a rejection without any further counter offer from said Seller of Product 840, central control system 101 follows said third set of pre-determined rules to exclude the lowest price, which is Offer J 830 from Buyer J 810, re-group the buyers.

After exclusion of Buyer J 810 who made Offer J 830, this invention allows a group of nine out of ten buyers to make a bid to purchase nine Products at the same time. As the result, said group of nine buyers, including Buyer A 801, Buyer B 802, Buyer C 803, Buyer D 804, Buyer E 805, Buyer F 806, Buyer G 807, Buyer H 808, and Buyer I 809 to form a Sixth Buyer Group. Buyer A 801 makes an Offer A 821 to bid for Product in the amount of $490; Buyer B 802 makes an Offer B 822 to bid for Product in the amount of $480; Buyer C 803 makes an Offer C 823 to bid for Product in the amount of $470; Buyer D 804 makes an Offer D 824 to bid for Product in the amount of $460; Buyer E 805 makes an Offer A 825 to bid for Product in the amount of $450; Buyer F 806 makes an Offer F 826 to bid for Product in the amount of $440; Buyer G 807 makes an Offer G 827 to bid for Product in the amount of $430; Buyer H 808 makes an Offer H 828 to bid for Product in the amount of $420; and Buyer I 809 makes an Offer I 829 to bid for Product in the amount of $410. As the result, central control system 101 following said second set of pre-determined rules to group all the bid amounts from said Sixth Buyer Group and communicate offer 835 to said Seller of Product 840. Said offer includes purchase of nine Products at a total price of $4,050, which is the sum all the offers, however, does not includes the identities of each individual buyer of said Sixth Buyer Group. Said Seller of Product 840 is provided certain time limit to respond to the central control system 101 regarding said offer. Said Seller of Product 840 communicates response 836 to the central control system 101. If the response 836 is acceptance of said offer 835, the central control system 101 informs said Sixth Buyer Group that said offer 835 has been accepted, and contract has been formed. If the response 836 is a rejection without any further counter offer from said Seller of Product 840, central control system 101 follows said third set of pre-determined rules to exclude the lowest price, which is Offer J 829 from Buyer J 809, and re-group the buyers. This process of re-group the buyers ends at the time either the offer 835 is accepted by said Seller of Product 840 or until Offer A 821, which is the highest offer to purchase Product from Buyer A 801 is rejected by said Seller of Product 840.

If the response 836 is a rejection with an counter offer from said Seller of Product 840, central control system 101 follows said third set of pre-determined rules to re-group offers from higher offer price to lower offer price to meet the requirement of the counter offer from said Seller of Product 840, and communicate offer 835 to said Seller of Product 840 to form a contract. Central control system 101 informs said Sixth Buyer Group that contract has been formed.

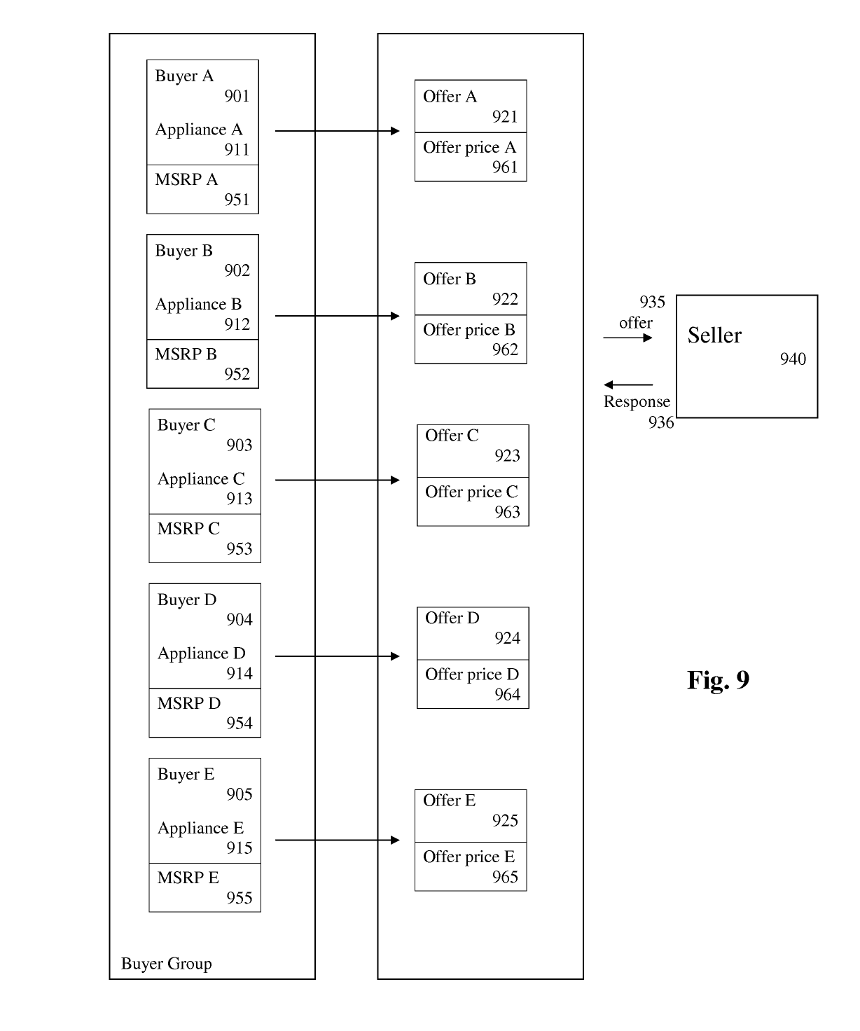

Referring now to FIG. 9, which is an illustration of Forth Application of the preferred embodiment of current invention. FIG. 9 illustrates an example of 5 buyers, each of whom intends to purchase a different appliance with different MSRP.

This invention allows this group of five buyers to make a bid to purchase five different appliance at the same time. Said first set of pre-determined rules allows central control system 101 to arrange and name such five buyers according to the offer price to MSRP ratio from high to low. As the result, said group of five buyers are named Buyer A 901, Buyer B 902, Buyer C 903, Buyer D 904, and Buyer E 905 to form a Seventh Buyer Group. Buyer A 901 makes an Offer A 921 to bid for Appliance A 911 with MSRP A 951 in the amount of offer price A 921 with offer price A 921 to MSRP A 951 ratio of 98%; Buyer B 902 makes an Offer B 922 to bid for Appliance B 912 with MSRP B 952 in the amount of offer price B 962 with offer price B 962 to MSRP B 952 ratio of 95%; Buyer C 903 makes an Offer C 923 to bid for Appliance C 913 with MSRP C 953 in the amount of offer price C 923 with offer price C 923 to MSRP C 953 ratio of 93%; Buyer D 904 makes an Offer D 924 to bid for Car D with MSRP D 954 in the amount of offer price D 964 with offer price D 964 to MSRP D 954 ratio of 91%; and Buyer E 905 makes an Offer E 925 to bid for Appliance E 915 with MSRP E 955 in the amount of offer price E 965 with offer price E 965 to MSRP E 955 ratio of 90%. As the result, central control system 101 following said second set of pre-determined rules to group all the bid amounts from said Seventh Buyer Group and communicate offer 935 to the Seller of Appliance 940. Said offer includes purchase of Appliance A 911, Appliance B 912, Appliance C 913, Appliance D 914, and Appliance E 915 all together at a total price of sum of offer price A 961, offer price B 962, offer price C 963, offer price D 964, and offer price E 965, however, does not includes the identities of each individual buyer of said Seventh Buyer Group. Said Seller of Appliance 940 is provided certain time limit to respond to the central control system 101 regarding said offer 935. The Seller of Appliance 940 communicates response 936 to the central control system 101. If the response 936 is acceptance of said offer 935, the central control system 101 informs said Seventh Buyer Group that said offer 935 has been accepted, and contract has been formed. If the response 936 is a rejection without any further counter offer from said Seller of Appliance 940, central control system 101 follows said third set of pre-determined rules to exclude the offer with the lowest offer price to MSRP ratio, which is Offer E 925 from Buyer E 905, re-group the buyers.

After exclusion of Buyer E 905 who made Offer E 925, this invention allows a group of four out of five buyers to make a bid to purchase Appliance A 911, Appliance B 912, Appliance C 913, and Appliance D 914 all together at the same time. As the result, said group of four buyers, including Buyer A 901, Buyer B 902, Buyer C 903, and Buyer D 904 to form an Eighth Buyer Group. Buyer A 901 makes an Offer A 921 to bid for Appliance A 911 with MSRP A 951 in the amount of offer price A 921 with offer price A 921 to MSRP A 951 ratio of 98%; Buyer B 902 makes an Offer B 922 to bid for Appliance B 912 with MSRP B 952 in the amount of offer price B 962 with offer price B 962 to MSRP B 952 ratio of 95%; Buyer C 903 makes an Offer C 923 to bid for Appliance C 913 with MSRP C 953 in the amount of offer price C 923 with offer price C 923 to MSRP C 953 ratio of 93%; and Buyer D 904 makes an Offer D 924 to bid for Appliance D with MSRP D 954 in the amount of offer price D 964 with offer price D 964 to MSRP D 954 ratio of 91%. As the result, central control system 101 following said second set of pre-determined rules to group all the bid amounts from said Eighth Buyer Group and communicate offer 935 to said Seller of Appliance 940. Said offer includes purchase of Appliance A 911, Appliance B 912, Appliance C 913, and Appliance D 914 all together at a total price of sum of offer price A 961, offer price B 962, offer price C 963, and offer price D 964, however, does not includes the identities of each individual buyer of said Eighth Buyer Group. Said Seller of Appliance 940 is provided certain time limit to respond to the central control system 101 regarding said offer 935. Said Seller of Appliance 940 communicates response 936 to the central control system 101. If the response 936 is acceptance of said offer 935, the central control system 101 informs said Eighth Buyer Group that said offer 935 has been accepted, and contract has been formed. If the response 936 is a rejection without any further counter offer from said Seller 940, central control system 101 follows said third set of pre-determined rules to exclude the offer with the lowest offer price to MSRP ratio, which is Offer E 925 from Buyer E 905, re-group the buyers. This process of re-group the buyers ends at the time either the offer 935 is accepted by said Seller of Appliance 940 or until Offer A 921, which is the highest offer with offer price to MSRP ratio to purchase Appliance A 911 from Buyer A 901 is rejected by said Seller of Appliance 940.

If the response 936 is a rejection with an counter offer from the Seller of Appliance 940, central control system 101 follows said third set of pre-determined rules to re-group offers from higher offer price to MSRP ratio to lower offer price to MSRP ratio to meet the requirement of the counter offer from said Seller of Appliance 940, and communicate offer 935 to said Seller of Appliance 940 to form a contract. Central control system 101 informs said Eighth Buyer Group that contract has been formed.

This group bidding system and method demonstrated by FIGS. 8 and 9 provides a group of buyers with the best possibility for the largest number of products to be sold by seller to said group buyers at the prices offered by said group of buyers. In a traditional product purchase scenario, there are usually three parties involved, including product manufacturer, product retailer and product buyer. Manufacturer sets the whole sale prices for the products to be sold to the retailers. Retailers set up the retail prices for the products to be sold to the buyers. Retailers have the bargaining power over the individual buyers. This group bidding system and method demonstrated by FIGS. 8 and 9 groups different buyers into a buyer group, some individual of which might be able to purchase the product below retailer's willing-to-sell price, because some others are willing to purchase the products above retailer's willing-to-sell price. This group bidding system and method helps a group of product buyers to purchase a number of products at a lowest possible average price that just above retailer's willing-to-sell price. This group bidding system and method might. be able to help the manufacturers of product to sale directly to a group of buyers, rather than through retailers, a method of which incurs so much inventory costs for retailers.

Such system and method demonstrated above could also be used in dealing products other than cars, such as appliances, electronics, equipments, as well as services.

As various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

I claim:

1. A group bidding system capable of aggregating purchase offers of at least one product from multiple buyers and bidding such purchase offers to one seller or multiple sellers of said at least one product, said group bidding system comprising:
a central control system, said central control system capable of processing said purchase offers of at least one product from said multiple buyers and communicating said purchase offers to said one seller or said multiple sellers of said product;
a database, said database being controlled and accessed by said central control system;
a buyer interface, said buyer interface being controlled by said central control system, and being accessed by both said central control system and said multiple buyers;
a seller interface, said seller interface being controlled by said central control system, and being accessed by both said central control system and said one seller or said multiple sellers;
a credit verification interface, said credit verification interface being accessed by both said central control system, said multiple buyers, and said one seller or said multiple sellers; and
a payment interface, said payment interface being accessed by both said central control system, said multiple buyers, and said one seller or said multiple sellers.

2. The group bidding system of claim 1, wherein said central control system is capable of processing said purchase offers of at least one product from said multiple buyers according to a first set of pre-determined rules, said first set of pre-determined rules being disclosed to said multiple buyers, and communicating such purchase offers to said one seller or said multiple sellers of said product according to a second set of pre-determined rules, said second set of pre-determined rules being disclosed to said one seller or said multiple sellers.

3. The reverse auction system of claim 1, wherein said central control system is capable of repeating a routine of process of said purchase offers of at least one product from said multiple buyers according to said first set of pre-determined rules, and communicating said purchase offers to said one seller or said multiple sellers of said product according to said second set of pre-determined rules, according to a third set of pre-determined rules, said third set of pre-determined rules including exclusion of one or more lowest purchase offers from said purchase offers before repeating said routine of process of said purchase offers and communicating said purchase offers.

4. The group bidding system of claim 1, wherein said purchase offers of at least one product from said multiple buyers include different offer prices of said at least one product, the sum of said diffident offer prices of said at least one product being communicated to said one seller or said multiple sellers of said at least one product.

5. The group bidding system of claim 1, wherein said one seller or said multiple sellers of said at least one product has a choice to either accept, reject, or accept part and reject part of said purchase offers of said at least one product from said multiple buyers.

6. The group bidding system of claim 1, wherein said multiple buyers, whose said purchase offers being accepted by said one seller or said multiple sellers, cannot withdraw said purchase offers upon acceptance by said one seller or said sellers.

7. A group bidding system capable of aggregating conditional purchase offers of at least one product from multiple buyers and communicating such conditional purchase offers to one seller or multiple sellers of said at least one product, said group bidding system comprising:
a central control system;
a database, said database being administrated by said central control system;
a buyer interface, said buyer interface being administrated by said central control system;
a seller interface, said seller interface being administrated by said central control system;
a credit verification interface, said credit verification interface being administrated by said central control system; and
a payment interface, said payment interface being administrated by said central control system.

8. The group bidding system of claim 7, wherein said central control system is capable of processing conditional purchase offers to purchase said at least one product from said multiple buyers according to a first set of pre-determined rules, said first set of pre-determined rules being disclosed to said multiple buyers, and communicating said aggregated conditional purchase offers to said one seller or said multiple sellers of said at least one product according to a second set of pre-determined rules, said second set of pre-determined rules being disclosed to said one seller or said multiple sellers.

9. The group bidding system of claim 8, wherein said central control system is capable of repeating a routine of process of said conditional purchase offers of at least one product from said multiple buyers according to said first set of pre-determined rules, and communicating said conditional purchase offers to said one seller or said multiple sellers of said at least one product according to said second set of pre-determined rules, according to a third set of pre-determined rules, said third set of pre-determined rules including exclusion of one or more lowest conditional purchase offers from said conditional purchase offers before repeating said routine of process of said conditional purchase offers and communicating said conditional purchase offers .

10. The group bidding system of claim 9, wherein said conditional purchase offers of at least one product from said multiple buyers include different conditional purchase offers of said product, the sum of said diffident conditional purchase offers of said at least one product being communicated to said one seller or said multiple sellers of said at least one product.

11. The group bidding system of claim 10, wherein said one seller or said multiple sellers of said at least one product has a choice to either accept, reject, or accept part and reject part of said aggregated conditional purchase offers of at least one product from said multiple buyers.

12. The group bidding system of claim 11, wherein said multiple buyers, whose conditional purchase offers being accepted by said one seller or said multiple sellers, cannot withdraw said conditional purchase offers upon acceptance by said one seller or said sellers.

13. A group bidding method capable of aggregating conditional purchase offers of at least one product from multiple buyers and communicating such conditional purchase offers to one seller or multiple sellers of said at least one product, said group bidding method comprising:
gathering conditional purchase offers from said multiple buyers for at least one product by a central control system;
processing said conditional purchase offers by said central control system according to a first set of pre-determined rules, said first set of pre-determined rules being disclosed to said multiple buyers;
communicating said conditional purchase offers by said central control system to one seller or multiple sellers of said at least one product according to a second set of pre-determined rules, said second set of pre-determined rules being disclosed to said one seller or said multiple sellers;
receiving a decision by said central control system from said one seller or said multiple sellers; and
communicating said decision by said central control system to said multiple buyers.

14. The group bidding method of claim 13, wherein said central control system comprises
a database, said database being controlled and accessed by said central control system;
a buyer interface, said buyer interface being controlled by said central control system, and accessed by both said central control system and said multiple buyers;
a seller interface, said seller interface being controlled by said central control system, and accessed by both said central control system and said one seller or said multiple sellers;
a credit verification interface, said credit verification interface being accessed by both said central control system, said multiple buyers, and said one seller or said multiple sellers; and
a payment interface, said payment interface being accessed by both said central control system, said multiple buyers, and said one seller or said multiple sellers.

15. The group bidding system of claim 13, wherein said central control system is capable of repeating a routine of processing said conditional purchase offers of said at least one product from said multiple buyers according to said first set of pre-determined rules, and communicating said conditional purchase offers to said one seller or said multiple sellers of said at least one product according to said second set of pre-determined rules, according to a third set of pre-determined rules, said third set of pre-determined rules including exclusion of one or more lowest conditional purchase offers from said conditional purchase offers before repeating said routine of processing said conditional purchase offers and communicating said conditional purchase offers, upon receiving a decision by said central control system from said one seller or said multiple sellers, said decision being either rejection, or partial acceptance and partial rejection of said conditional purchase offers.

16. The group bidding method of claim 13, wherein said conditional purchase offers of said at least one product from said multiple buyers include different conditional offer prices of said product.

17. The group bidding method of claim 13, wherein said first set of pre-determined rules include a credit verification process of said multiple buyers through said credit verification interface, and a payment process by said multiple buyers for making said conditional purchase offers through said payment interface.

18. The group bidding method of claim 13, wherein said one seller or said multiple sellers makes decision to accept, reject, or partially accept and partially reject said conditional purchase offers.

19. The group bidding method of claim 13, wherein said multiple buyers, whose conditional purchase offers being accepted by said one seller or said multiple sellers, cannot withdraw said conditional purchase offers upon acceptance by said one seller or said multiple sellers.
